(19) United States
(12) Patent Application Publication
(10) Pub. No.: US 2004/0057705 A1
(43) Pub. Date: Mar. 25, 2004

(54) Motor driving apparatus

(75) Inventor: Takanori Kohno, Itabashi-ku (JP)

Correspondence Address: NIXON PEABODY, LLP, 401 9TH STREET, NW, SUITE 900, WASINGTON, DC, 20004-2128, US

(73) Assignee: NIDEC COPAL CORPORATION, Tokyo (JP)

(21) Appl. No.: 10/658,204

(22) Filed: Sep. 10, 2003

(30) Foreign Application Priority Data
Sep. 11, 2002 (JP) 2002-265600

(51) Int. Cl. H02P 5/06

(52) U.S. Cl. 388/806

(57) ABSTRACT

In a motor driving apparatus, a driving circuit drives a plurality of loads contained in a plurality of motors, and a control circuit controls the driving circuit to sequentially drive the motors. The driving circuit is provided with at least n+1 number of output terminals in order to connect thereto n number of loads, each of the output terminals being led out from a node of a PNP type transistor and an NPN type transistor connected in series through the node in such a configuration that each pair of the output terminals adjacent to one another constitute a bridge circuit assigned to drive one load. The control circuit turns on and off the PNP and NPN type transistors of the bridge circuit to thereby energize the load in either of a normal direction and a reverse direction. A particular one of the output terminals is led from a node of a particular PNP type transistor and a particular NPN transistor, one of which is driven by a constant electric current through a feedback loop and the other of which is driven by a constant electric current through an open loop. The particular output terminal and another output terminal adjacent thereto are paired to constitute a particular bridge circuit for driving a particular load by the constant electric current through either of the feedback loop and the open loop properly depending on whether the particular load is energized in the normal direction or the reverse direction.

### BACKGROUND OF THE INVENTION

1. Technical Field of the Invention

The invention relates to a motor driving apparatus constituted of a driver IC which integrally comprises a driving circuit for driving a plurality of loads (coils etc.) contained in a plurality of motors built in, for example, a camera and a control circuit for controlling the driving circuit to thus drive the plurality of motors sequentially.

2. Prior Art

For example, in a digital camera, there are built in a plurality of motors as sources for driving a variety of working parts. These may include a stepping motor, an iris motor, and a DC motor. In particular, as for a lens-barrel, a stepping motor is used to drive a lens for auto focusing. An iris motor is used to drive a shutter and a diaphragm. In some cases, the iris motor is replaced by the stepping motor, to drive a diaphragm. The DC motor is used to drive a zoom lens. In some cases, the DC motor is replaced by the stepping motor, to drive the zoom lens. These motor driving circuits are described in, for example, Patent Documents 1 and 2.

Patent Document 1 is Japanese Patent Application Laid-open No. 2000-231135. Patent Document 2 is Japanese Patent Application Laid-open No. 2001-318725.

The stepping motor is comprised of, for example, a multi-pole magnetized rotor, a stator, and a 2-phase coil in which two coils work as a load. Therefore, to drive the stepping motor, the driver IC is provided with a total of four output terminals in two pairs capable of driving at least two loads. Typically, each pair of output terminals correspond to one H-type bridge circuit, so that the driver IC comprises two H-type bridge circuits for driving the stepping motor. The iris motor is constituted of a 2-pole magnetized rotor and one coil. Therefore, to drive the iris motor, the driver IC needs to be provided with only one pair of output terminals. Furthermore, to drive the DC motor, at least one pair of output terminals are necessary.

Recent driver IC comprises a plurality of output terminals in order to drive a plurality of loads sequentially. A simple calculation indicates that 2n number of output terminals are necessary to drive n number of loads. If a pair of adjacent H-type bridge circuits share one output terminal, the number of necessary output terminals can be reduced from 2n to n+1. However, in this case, such a restriction occurs that the loads cannot simultaneously be driven. Recently, such a driver IC is under development having at least n+1 number of output terminals in order to connect to n (n: 2 or larger integer) number of loads. In this case, each of the output terminals is led out from a node of a PNP type transistor and an NPN type transistor that are connected in series through the rode, so that one pair of the adjacent output terminals are assigned to one load to constitute a bridge circuit. The four transistors of the bridge circuit are turned on and off to energize the connected load in normal and reverse directions.

According to characteristics of a load, either a constant electric current driving mode, a constant voltage driving mode, or a switching driving mode is selected appropriately. Therefore, a particular output terminal is provided with a constant electric current control function. Typically, a feedback loop type of constant electric current function is employed, comprising a current detection resistor connected to a drive transistor and an operational amplifier for controlling the drive transistor based on a value of a current detected through the current detection resistor.

The current detection resistor provides additional impedance to the particular output terminal that accommodates the constant electric current driving mode. It is necessary for the current detection resistor connected to the particular output terminal not to provide common impedance to an adjacent output terminal. Therefore, conventionally, a particular output terminal that accommodates the constant electric current driving mode has been separated from the other output terminals as an independent one so that it may not be shared by other output terminals in configuration.

On the other hand, in such a configuration that one H-type bridge circuit is used to energize one load as switching the load between normal and reverse directions, there is a case where it is desired to drive the load by a constant electric current in both directions. In this case, for each H-type bridge, a total of two constant electric current control feedback loops are necessary; one for the normal direction and the other for the reverse direction. Therefore, the current detection resistor is also required two. In such a configuration, inevitably at least one current detection resistor acts as impedance common to the adjacent output terminal. To avoid this, as described above, there has been employed either a method of completely separating independently an output stage that accommodates the constant electric current driving mode, or a method of employing the constant electric current driving mode only for one of normal energizing and reverse energizing and a different control mode for the other. By doing so, the current detection resistor is required only one so that by arranging the particular output stage at an extreme end, the one current detection resistor will not provide common impedance to the other output terminals. To conduct feedback loop-controlled constant electric current driving in both of the normal and reverse directions by any means, it may be thought of that the current detection resistor is provided above and below the H-type bridge circuit. However, in this case, it is inevitable that a driver IC has a larger number of external terminals of current detection resistors or current setting inputs to result in complexity of the circuit structure.

### SUMMARY OF THE INVENTION

In view of the above problems of the conventional technologies, it is an object of the invention to provide such a configuration of an IC that may not have a larger number of terminals and its current detection resistor may not provide common impedance to a next stage even in a case where a fist stage of the plurality of output terminals is adapted to accommodate a constant electric current driving mode in both normal and reverse directions.

To achieve the object, the following means have been provided. That is, a motor driving apparatus according to one aspect of the invention comprises a driving circuit for driving a plurality of loads contained in a plurality of motors, and a control circuit for controlling the driving circuit to sequentially drive the plurality of the motors. The driving circuit is provided with at least n+1 number of output terminals in order to connect thereto n (n: integer of 2 or larger) number of loads, each of the output terminals being led out from a node of a PNP type transistor and an NPN type transistor connected in series through the node in such a configuration that each pair of the output terminals adjacent to one another constitute a bridge circuit assigned to drive one load. The control circuit turns on and off the PNP and NPN type transistors of the bridge circuit to thereby energize the load in either of a normal direction and a reverse direction. A particular one of the output terminals is led from a node of a particular PNP type transistor and a particular NPN transistor, one of which is driven by a constant electric current through a feedback loop and the other of which is driven by a constant electric current through an open loop. The particular output terminal and another output terminal adjacent thereto are paired to constitute a particular bridge circuit for driving a particular load by the constant electric current through either of the feedback loop and the open loop properly depending on whether the particular load is energized in the normal direction or the reverse direction.

The motor driving apparatus having such a configuration can be applied to a camera for driving and controlling of a plurality of motors integrated in a lens-barrel provided with a plurality of mechanisms used in photographing by the camera which are selected from shutter, diaphragm, auto focusing, and zooming mechanisms.

Specifically, the feedback loop comprises a current detection resistor connected to the one of the particular PNP type transistor and the particular NPN transistor for detecting an electric current flowing therethrough, and an operational amplifier for controlling said one of the particular PNP type transistor and the particular NPN transistor based on an electric current detected by the current detection resistor. The open loop comprises a current mirror transistor that is mirror-connected to the other of the particular PNP type transistor and the particular NPN transistor, and a current setting resistor that is connected to the current mirror transistor for setting the constant electric current flowing therethrough.

Preferably, the driving circuit and the control circuit are integrated into one IC chip, so that the IC chip internally generates a reference voltage inputted to the operational amplifier of the feedback loop for setting the constant electric current, and the current setting resistor of the open loop is connected to the IC chip externally.

Practically, the particular bridge circuit constituted of the particular output terminal drives as the particular load a motor contained in a digital camera for opening and closing a shutter in such a manner that the motor is driven by the constant electric current through the open loop when opening the shutter and driven by the constant electric current through the feedback loop when closing the shutter.

By the invention, for example, a first-stage of the output terminals that constitute a bridge circuit is driven by a constant electric current in such a manner that ordinary feedback loop-type constant-current control may be conducted in one of normal and reverse energizing directions and open loop-type constant-current control may be conducted in the other direction. By doing so, the current detection resistor is required only in the feedback loop, so that no common impedance is added to a next stage. That is, the current detection resistor connected to the first stage is not involved in driving of the next stage and so will not affect control characteristics.

It is to be noted that by energizing the load by the open loop in the other direction, a control accuracy is deteriorated as compared to the feedback loop (closed loop). The deterioration, however, can be compensated for by selecting a driving direction in such a manner as to meet a required accuracy of the load to be driven. For example, if a motor that opens and closes a shutter in a digital camera is energized as a load, basically an exposure quantity is determined by a shutter closing operation in the case of the digital cameras, so that a shutter opening operation has no influence on an exposure accuracy. That is, the shutter opening operation flows a smaller driving current and does not require a higher control accuracy, whereas the shutter closing operation is high in speed and requires a higher accuracy. In this case, properly the shutter opening operation is effected by open loop-type driving of the motor by a constant electric current, and the shutter closing operation is conducted by the feedback loop-type control.

### BRIEF DESCRIPTION OF THE DRAWINGS

FIG. 1 is a schematic circuit diagram for showing a motor driving apparatus related to the invention.

FIG. 2 is a circuit diagram for showing an example of connecting loads to the motor driving apparatus shown in FIG. 1.

FIG. 3 is another example of connecting loads to the motor driving apparatus shown in FIG. 1.

FIG. 4 is a further example of connecting loads to the motor driving apparatus shown in FIG. 1.

FIG. 5 is a logic table for explaining operations of the motor driving apparatus shown in FIG. 1.

FIG. 6 is another logic table for explaining operations of the motor driving apparatus shown in FIG. 1.

FIG. 7 is a schematic diagram for showing a lens-barrel driving apparatus for a camera according to an application of the invention.

### DETAILED DESCRIPTION OF THE INVENTION

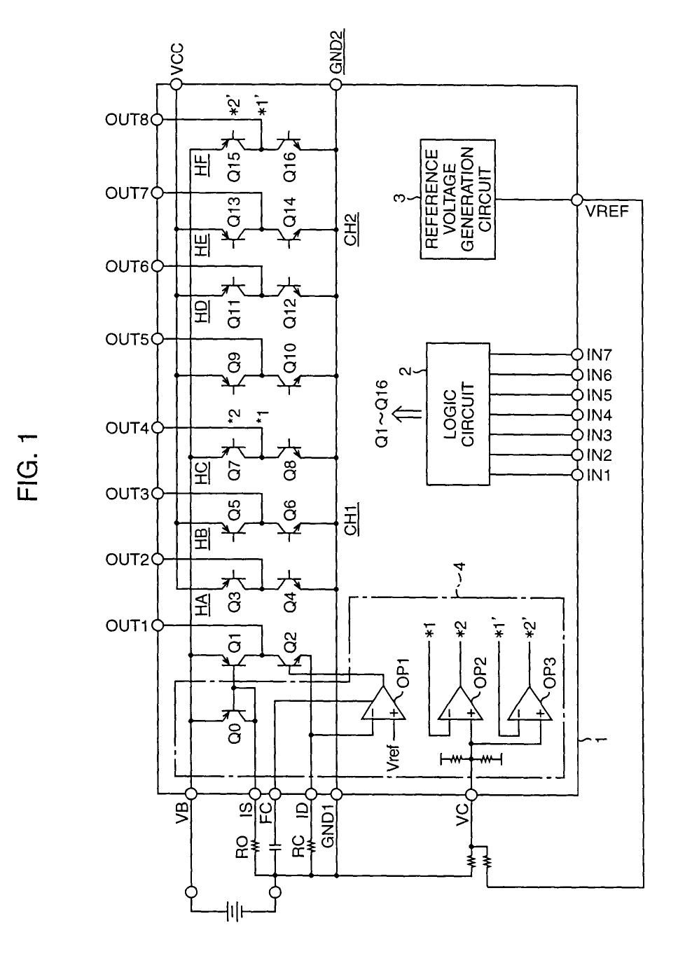

The following will describe in detail embodiments of the invention with reference to drawings. FIG. 1 is a schematic circuit diagram for showing a motor driving apparatus related to the invention. The present motor driving apparatus comprises a driving circuit for driving a plurality of loads (not shown) contained in a plurality of motors and a control circuit for controlling the driving circuit to thus drive the plurality of motors sequentially. The driving circuit is divided into two channels of CH1 and CH2 that are controlled by the control circuit concurrently. One of the channels CH1 is controlled by the control circuit in such a manner that the plurality of loads can be driven selectively. The other channel CH2 is also controlled by the control circuit in such a manner that the plurality of loads can be driven selectively. The control circuit is constituted of a logic circuit 2 shown in the figure. The channels CH1 and CH2 and the logic circuit 2 are formed integrally into a driver IC1, thereby constituting the motor driving apparatus related to the invention. It is to be noted that the driver IC1 has built-in reference voltage generation circuit 3 and constant voltage/constant electric current circuit 4 as well as the two channels CH1 and CH2 and the logic circuit 2. To connect these internal circuits to an outside, the driver IC1 is provided with 24 connection terminals. Therefore, a 24-pin standard package can be used for the present driver IC. The 24 connection terminals include output terminals OUT1-OUT8, control input terminals IN1-IN7, ground terminals GND1 and GND2, power supply terminals VB and VCC, and other terminals FC, ID, IS, VC, and VREF. The terminal VREF is provided to output therefrom a reference voltage VREF generated internally by the reference voltage generation circuit 3. The terminal VC is provided to supply a referral voltage VC to the constant voltage/constant electric current circuit 4. The terminal IS is provided to supply a referral current to the same constant electric current/constant voltage circuit 4. The terminal ID is provided to supply a detected current to the constant electric current/constant voltage circuit 4. It is to be noted that in the constant electric current/constant voltage circuit 4, a constant electric current unit is constituted of an operational amplifier OP1 and a transistor Q0, and a constant voltage unit is constituted of operational amplifiers OP2 and OP3. It is also to be noted that in the present example, the ground terminals GND1 and GND2 are connected to each other in the driver IC1.

In the present IC configuration, two power supplies VB and VCC are used properly depending on required characteristics of the loads connected. That is, the power supply VB is used for such a heavy load as to need a high accuracy (DC motor etc.), while the other power supply VCC is used for such a light load as to need a relatively low accuracy. Of course, there is no problem in using a single power supply obtained by interconnecting the power supplies VB and VCC.

The following will describe in particular the constant electric current unit, which features the invention, of the constant electric current/constant voltage circuit 4 in detail. As shown in the figure, the constant electric current unit conducts constant-current control on a PNP type transistor Q1 and on an NPN type transistor Q2 that continues to the first stage output terminal OUT1 of the eight output terminals OUT1 through OUT8. Specifically, constant-current control is conducted on the NPN type transistor Q2 through the feedback loop and on the PNP type transistor Q1 through the open loop. By providing such a configuration, it is possible to conduct constant-current control on a load connected between the first stage output terminal OUT1 and the next stage output terminal OUT2 using the feedback loop and the open loop properly depending on an energizing direction. For example, a bridge circuit HA constituted of the output terminals OUT1 and OUT2 can energize as a load a motor built in a digital camera for opening and closing a shutter. In this case, to open the shutter, the load is energized in the normal direction from OUT1 to OUT2. Then, the transistor Q1 and Q4 are turned ON. Therefore, to open the shutter, the motor is driven by a constant electric current through the open loop. To close the shutter, on the other hand, the motor is energized in the reverse direction from OUT2 to OUT1. Then, the transistors Q3 and Q2 are turned ON. Therefore, to close the shutter, the motor is energized by a constant electric current through the feedback loop.

The feedback loop comprises a current detection resistor RC connected to an emitter of the NPN type transistor Q2 and an operational amplifier OP1 for controlling the transistor Q2 based on a current value detected by the current detection resistor RC. The open loop, on the other hand, comprises the transistor Q0 mirror-connected to the transistor Q1 and a current setting resistor RO connected to the transistor Q0. As shown in the figure, the current detection resistor RC belonging to the feedback loop is an external resistor element connected to the connection terminal ID of the driver IC1. Similarly, the current setting resistor RO belonging to the open loop is also an external resistor element connected to the connection terminal IS of the driver IC1.

On the other hand, a reference voltage Vref for setting a current to be input to the operational amplifier OP1 of the feedback loop is generated in the driver IC. Specifically, the reference voltage VREF generated by the reference voltage generation circuit 3 built in the driver IC1 is appropriately divided by a resistor internally to provide the reference voltage Vref for the operational amplifier OP1.

As described above, the load is energized in the normal direction from OUT1 to OUT2 by placing the PNP transistor Q1 on the side of OUT1 under the open loop-type constant electric current-drive control. In this case, the open loop circuit has a mirror circuit configuration constituted of a drive stage of one pair of PNP transistors Q0 and Q1 having a common base. A drive current becomes a set multiple factor of a value of a current flowing through the mirror drive stage. The set multiple factor is represented by an emitter area ratio between the transistor Q0 of the mirror drive stage and the drive stage transistor Q1 and determined physically in configuration. Typically, the setting multiple factor is determined to a value of several tens. In this configuration, the drive stage current is set by the current setting resistor RO.

On the other hand, the load is energized in the reverse direction from OUT2 to OUT1 by using the OP1 in the constant-current driving mode by means of feedback loop control. A magnitude of the drive current is set by the internal reference voltage Vref supplied to a positive input terminal of the OP1 and the external load resistor RC connected via the connection terminal ID. In such a configuration, the driver IC1 capable of conducting control feedback that meets characteristics of loads such as the shutter, diaphragm, AF, and zooming mechanisms, can be constituted in a 24-pin small-size standard package. In opening the shutter by energizing the load in the normal direction from OUT1 to OUT2 and closing the shutter by energizing the load in the reverse direction from OUT2 to OUT1, a required accuracy can be satisfied in both of the energizing directions. Further, various currents can be set respectively by the externally mounted resistors RC and RO. It is to be noted that when conducting constant electric current control in the feedback loop, it is necessary to connect a capacitor to the terminal FC in parallel with the current detection resistor RC in order to stabilize operations. When conducting constant electric current control in the open loop, on the other hand, it is not necessary to connect the capacitor in parallel with the current setting resistor RO in particular.

Operations of the driver IC1 are described continuously with reference to FIG. 1. Typically, a channel is adapted to drive n (n: integer of 2 or larger) number of loads and so has n+1 number of output terminals so that one pair of the output terminals may be assigned to drive one of the loads. At least one of each pair of the output terminals is commonly used by two loads. Therefore, the control circuit controls the output terminals of each of the channels so that a plurality of the loads may not simultaneously be driven by this one channel. Since n=3 in the present embodiment and the channel CH1 connects three loads thereto, it has the four output terminals OU1 through OUT4, so that each pair of the output terminals are assigned to drive each of the loads. For example, one of the loads is connected to the respective ends of the pair of output terminals OUT1 and OUT2. The second load can be connected to the respective ends of OUT2 and OUT3. Similarly, the third load can be assigned to the output terminals OUT3 and OUT4. In this configuration, at least one of each pair of the output terminals assigned to one of the loads is commonly used by another one of the loads. For example, OUT2 is commonly used by the first and second loads. Also, OUT3 is commonly used by the second and third loads. In this relationship, the control circuit controls the output terminals OUT1 through OUT4 of the channel CH1 so that the three loads connected to CH1 may not be driven simultaneously. The channel CH2 has a configuration similar to that of the CH1 in having the four output terminals OUT5 through OUT8.

The control circuit can control the channels CH1 and CH2 both independently of each other or concurrently. Therefore, even in a case where two loads contained in one stepping motor is divided and assigned to the channels CH1 and CH2 respectively, the stepping motor can be driven normally as in the case of an ordinary driver IC.

Between each pair of the output terminals, a bridge circuit is connected. Each of the bridge circuits can be connected between the power supply lines VCC and VB and the ground lines GND1 and GND2, to supply a drive current in both directions to the corresponding one of the loads under the control of the control circuit. For example, as for the channel CH1, between the pair of output terminals OUT1 and OUT2, the bridge circuit HA comprised of the four transistors Q1 through Q4 is connected. The bridge circuit HA supplies a drive current in both directions to the corresponding one of the loads under the control of the control circuit. Accordingly, the motor can rotate in both directions. Specifically, if the transistors Q1 and Q4 of the four transistors constituting the bridge circuit HA are turned ON and the transistors Q2 and Q3 are turned OFF, a normal-directional drive current flows through the load from OUT1 to OUT2. If, oppositely, the transistors Q1 and Q4 are turned OFF and the transistors Q2 and Q3 are turned ON, a reverse-directional drive current flows through the load from OUT2 to OUT1. Similarly, between the next pair of output terminals OUT2 and OUT3, a bridge circuit HB comprised of the transistors Q3 through Q6 is connected. Note here that the bridge circuits HA and HB commonly use the transistors Q3 and Q4. Between the further next pair of output terminals OUT3 and OUT4, a bridge circuit HC comprised of transistors Q5 through Q8 is connected. The channel CH2 also has a configuration similar to that of the channel CH1 in that a bridge circuit HD is connected between OUT5 and OUT6, a bridge circuit HE is connected between OUT6 and OUT7, and a bridge circuit HF is connected between OUT7 and OUT8. To constitute the three bridge circuits HD, HE, and HF, eight transistors Q9 through Q16 are used.

The logic circuit 2 that constitutes the control circuit controls the driving circuit by outputting a first kind of control signal for selecting at least one of the two channels CH1 and CH2, a second kind of control signal for specifying a load to be driven by the selected channel, and a third kind of control signal for specifying a direction in which the load rotates, in response to 7-bit sequence data supplied through the input terminals IN1-IN7. Specifically, in response to the 7-bit sequence data input through the seven input terminals IN1-IN7, the logic circuit 2 outputs the first kind through third kind of control signals to thereby supply the control signal (base current) to turn ON/OFF the transistors Q1-Q16 of the bridge circuits contained in the channels CH1 and CH2.

One half of the bridge circuit HA among the plurality of bridge circuits HA through HF is driven by a constant electric current in both directions by the transistor Q0 contained in the constant electric current/constant voltage circuit 4 or the operational amplifier OP1. One half of the bridge circuit HC is driven by a constant voltage by the operational amplifier OP2 contained in the constant electric current/constant voltage circuit 4. Similarly, one half of the bridge circuit HF is driven by a constant voltage by the operational amplifier OP3 contained in the constant electric current/constant voltage circuit 4.

The motor driving circuit shown in FIG. 1 is supposed to be capable of intra-channel driving that one pair of output terminals in one channel are assigned to drive one load and inter-channel driving that one pair of output terminals are assigned between two channels. The following will specifically describe this respect with reference to an example of driving a lens barrel of a digital camera. To drive the lens barrel, shutter, diaphragm, AF, and zooming functions are used. As for actuators used in such driving, an actuator of the shutter function is an iris motor (IM) and constituted of one load. An actuator of the diaphragm function may be constituted of one or two iris motors or a stepping motor (STM). An actuator of the AF function is constituted of a stepping motor in many cases. An actuator of the zooming function may be constituted of either a stepping motor or a DC motor (DCM). In a case where a stepping motor is used for zooming, it is necessary to drive each of two loads (coils) in normal and reverse directions. In a case where a DC motor is used for zooming, it is necessary to drive one load in the normal and reverse directions and brake the driving. Driving braking here means to conduct control so as to short-circuit two ends of the coil. FIG. 1 shows a layout of a motor driving apparatus capable of commonly driving these combined types of actuators in a minimum driving circuit configuration. As described above, the basic driving circuit comprises serially connected switch circuits provided on positive polarity and negative polarity sides of a driving power supply and four groups of switch columns having each inter-switch node serving as an output terminal in such a configuration that a load is connected between each of the adjacent pairs of output terminals to enable driving a total of three loads, which configuration is provided as many as two each for each of the channels CH1 and CH2. Since the loads are interconnected in each of the channels, they cannot be driven simultaneously. Further, when allocating the actuator loads to the two channels of CH1 and CH2, it is necessary to distribute the two coils over the two channels CH1 and CH2 because a stepping motor has a timing at which the two coils are energized simultaneously (2-phase driving).

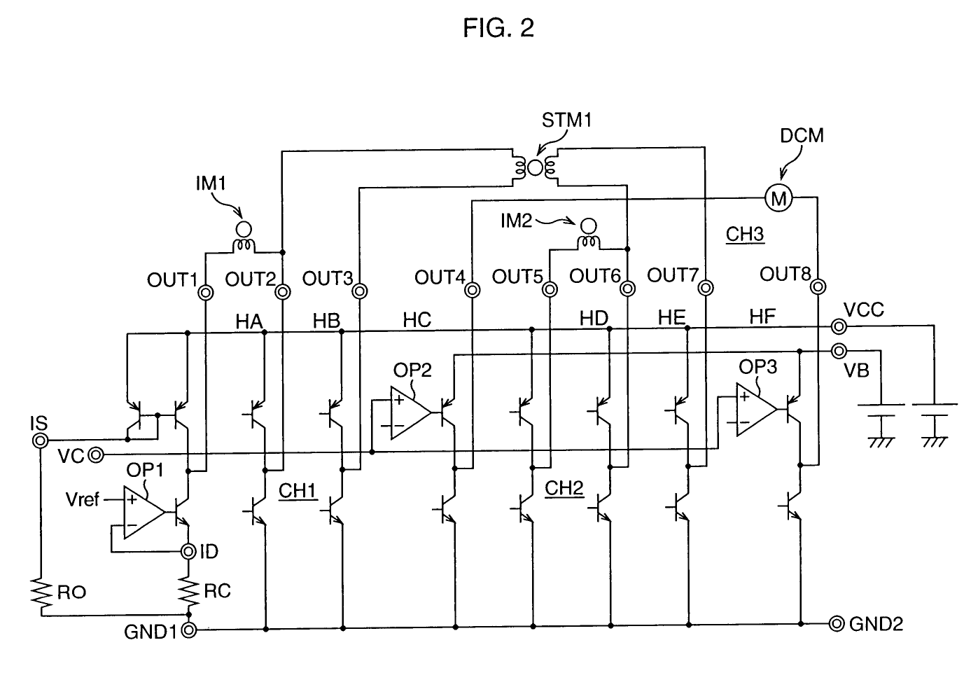

FIG. 2 is a circuit diagram for showing an example of connection in which inter-channel driving is employed in the motor driving apparatus shown in FIG. 1 in addition to intra-channel driving. For easy understanding, components in FIG. 2 corresponding to those in FIG. 1 are indicated by the corresponding reference numerals. To drive the shutter of the digital camera, a 1-coil iris motor IM1 is connected between the pair of output terminals OUT1 and OUT2. The iris motor IM1 is subject to open loop-controlled constant electric current driving by means of a current mirror circuit constituted of the externally mounted current setting resistor RO and one pair of PNP transistors in a direction in which the shutter is opened and, in a direction in which it is closed, subject to feedback loop-controlled constant electric current driving by means of the load resistor RC and the operational amplifier. Generally, in a digital camera, an exposure quantity depends on the closing operation. Therefore, in the closing operation, the constant electric current driving mode by use of a feedback loop capable of control at high speed and high accuracy is employed. On the other hand, in the shutter opening operation, which has no direct influence on the exposure quantity in the digital camera, the open loop-type constant electric current control mode is employed. By thus using the feedback loop and the open loop properly also in constant electric current control depending on the energizing direction, the current detection resistor connected in series with the load is required only one. With this, the current detection resistor is not involved in energizing of the next output terminal and so will not provide common impedance. It is thus possible in the present example to integrate the current detection resistor into the IC chip together with the driving circuit and the control circuit, so that a reference voltage is generated in the IC for setting a current to be input to the operational amplifier similarly integrated, thus forming the feedback loop.

The diaphragm is driven by another 1-coil iris motor IM2. This iris motor IM2 is connected between the output terminals OUT5 and OUT6 and driven by switching normally. A 2-coil stepping motor STM1 is used for AF. One of the coil loads of the STM1 is connected between the output terminals OUT2 and OUT3 of the channel CH1 and the other coil load is connected between the output terminals OUT6 and OUT7 of the channel CH2. These coil loads are each driven normally by switching. The remaining zooming function is realized by a DC motor DCM. The DCM has one terminal thereof connected to the output terminal OUT4 of the channel CH1 and the other terminal thereof connected to the output terminal OUT8 of the channel CH2, to be driven by a constant voltage. As may be clear from the above, the loads contained in the iris motor IM1 for the shutter, the iris motor IM2 for the diaphragm, and the stepping motor STM1 for AF are all driven in the intra-channel mode. On the other hand, DC motor DCM for zooming is in the inter-channel driving mode. In the inter-channel driving mode, the output terminal OUT4 is released from connection with the remaining output terminals OUT1-OUT3 in the channel CH1 and so can be driven independently. Similarly, in the channel CH2 also, the output terminal OUT8 has also been released from connection with the remaining output terminals OUT5-OUT7 and so can be driven independently. Therefore, the DC motor DCM for zooming, if placed in the inter-channel driving mode, can be driven independently of the other loads. Accordingly, the DC motor DCM for zooming can be driven simultaneously with the iris motor IM2 for diaphragm or the stepping motor STM1 for AF when necessary. In such a manner, one pair of the output terminals OUT4 and OUT8 separated from the CH1 and the CH2 respectively constitute a third channel CH3. By driving the DC motor DCM by the third channel CH3, it can be driven simultaneously with the other motors.

Now, merits of placing the DC motor DCM for zooming in the inter-channel driving mode are described as follows. Optical properties of the lens-barrel give rise to a request for altering setting of the AF and diaphragm mechanisms in accordance with a degree of zooming. In a case where the stepping motor is used for zooming, it can be driven sequentially with the other stepping motors, whereas in a case where the DC motor is used for zooming, it cannot be done so. Therefore, when the DC motor is used, it needs to be driven simultaneously with the other motors. Accordingly, as shown in FIG. 2, when driving the stepping motor and the DC motor simultaneously, the DC motor is actually placed in the inter-channel driving mode so as to be released from the other loads of each channel and then can be driven simultaneously.

Further, the DC motor tolerates a large actuation current flowing through it owing to its properties and so has a large driving capacity. Therefore, the driving circuit needs to have a small switching loss at a large current output. If the DC motor is supposed to be in the intra-channel driving mode, any other loads that commonly use a switch side of the bridge circuit have different driving capacities between a normal directional rotation and a reverse directional rotation. Preferably, the stepping motor, for example, has a stable driving capacity in order to avoid step-out. In order to avoid such an unbalance between the normal and reverse directions, preferably the DC motor is driven commonly by the channels. Further, the driver IC needs to have a large chip area, in its structure design, in order to reserve a sufficient drive capacity. Therefore, the large-area portion should preferably extend over the channels for convenience in designing of ICs in many cases.

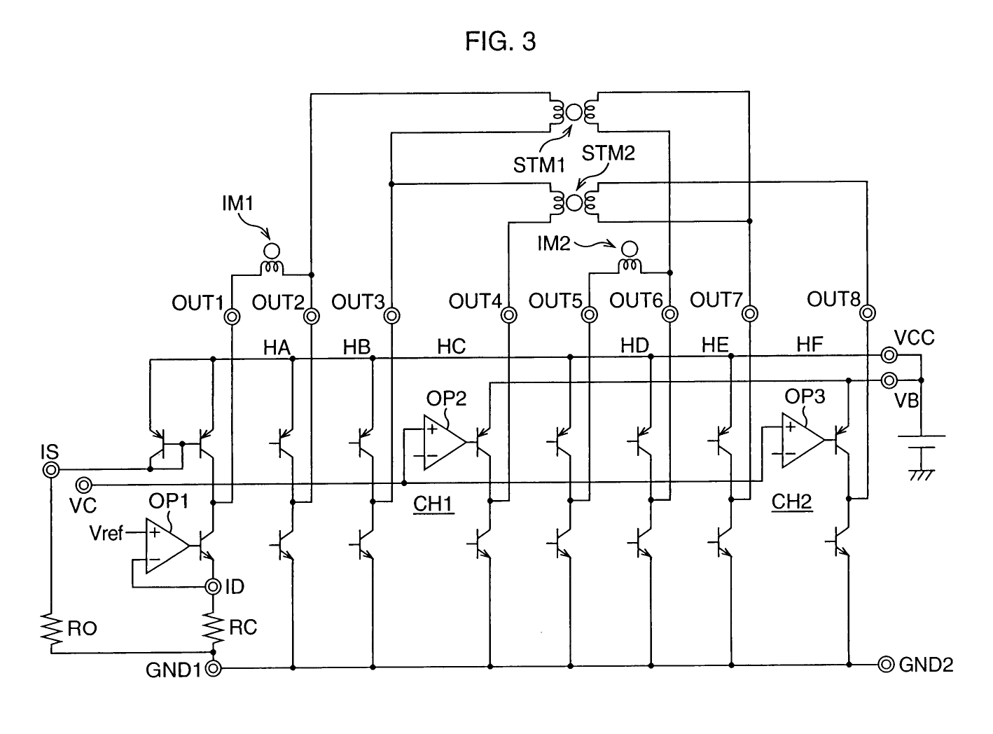

FIG. 3 shows another example of connection of the loads to the motor driving apparatus related to the invention. For easy understanding, components in FIG. 3 corresponding to those in FIG. 2 are indicated by the corresponding reference numerals. The present example is different from the example of FIG. 2 in that a stepping motor STM2 is used in place of the DC motor DCM for zooming. The stepping motor STM2 has one coil thereof connected between the output terminals OUT3 and OUT4 of the channel CH1 and the other coil thereof connected between the output terminals OUT7 and OUT8 of the other channel CH2. In this construction, coil loads of the zooming stepping motor STM2 are both in the intra-channel driving mode, so that the stepping motor STM2 cannot be driven simultaneously with the other motors. However, the stepping motor STM2 can be driven sequentially as coordinated with the other motors STM1 and IM2 and so gives rise to no problem.

In the present example, the stepping motors STM1 and STM2 are used for AF and zooming. Therefore, each channel requires two outputs, so that remaining two outputs are allocated for the shutter and the diaphragm respectively. That is, the shutter is driven by the iris motor IM1 on the side of the channel CH1 and the diaphragm is driven by the iris motor IM2 on the side of the channel CH2. In such a manner, in the present example, a total of six loads contained in the STM1, STM2, IM1, and IM2 are driven, thus exerting a maximum capacity. In the preceding example of FIG. 2, on the other hand, a total of five loads contained in the STM1, IM1, IM2, and DCM are driven, thereby providing a configuration having an extra of one load.

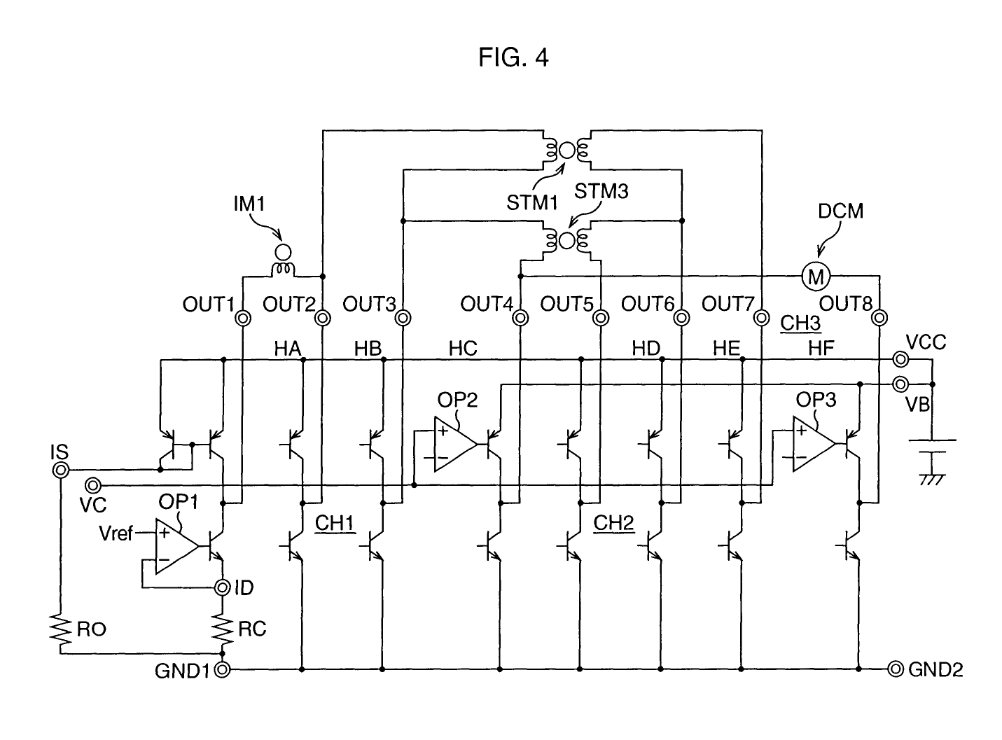

FIG. 4 shows a further example of connection. For easy understanding, components in FIG. 4 corresponding to those in FIG. 2 are indicated by the corresponding reference numerals. The present example is different from the example of FIG. 2 in that a stepping motor STM3 is used for diaphragm in place of the iris motor IM2. The stepping motor STM3 has one coil thereof connected between the output terminals OUT3 and OUT4 of the channel CH1 and the other coil thereof connected between the output terminals OUT5 and OUT6 of the channel CH2. In the present example also, a total of six loads contained in the STM1, STM3, IM1, and DCM are driven by the channel CH1 and CH2, thereby exerting a maximum capacity.

As can be seen from comparison between the example of FIG. 3 and that of FIG. 4, a predetermined group of the terminals OUT2, OU3, OUT6, and OUT7 are allocated as they are to the stepping motor STM1 for AF. In contrast, the stepping motor STM2 used in FIG. 3 is allocated the terminals OUT3, OUT4, OUT7, and OUT8, whereas the stepping motor STM3 of FIG. 4 is allocated the output terminals OUT3, OUT4, OUT5, and OUT6. In such a manner, when driving one stepping motor containing at least two loads sequentially with another motor, one of loads of the stepping motor is driven by one of the channels and the other load is driven by the other channel. In this case, in accordance with a combination with the another motor, it is made possible to appropriately change one pair of output terminals to be allocated to the stepping motor in at least one of the two channels, thereby giving a large degree of freedom in connection configuration. That is, the stepping motors STM2 and STM3 are both allocated one pair of the output terminals OUT3 and OUT4 in the channel CH1 but different from each other in allocation in the channel CH2. That is, the load of the stepping motor STM2 is connected between the OUT7 and OUT8, whereas the load of the stepping motor STM3 can be connected between the output terminals OUT5 and OUT6.

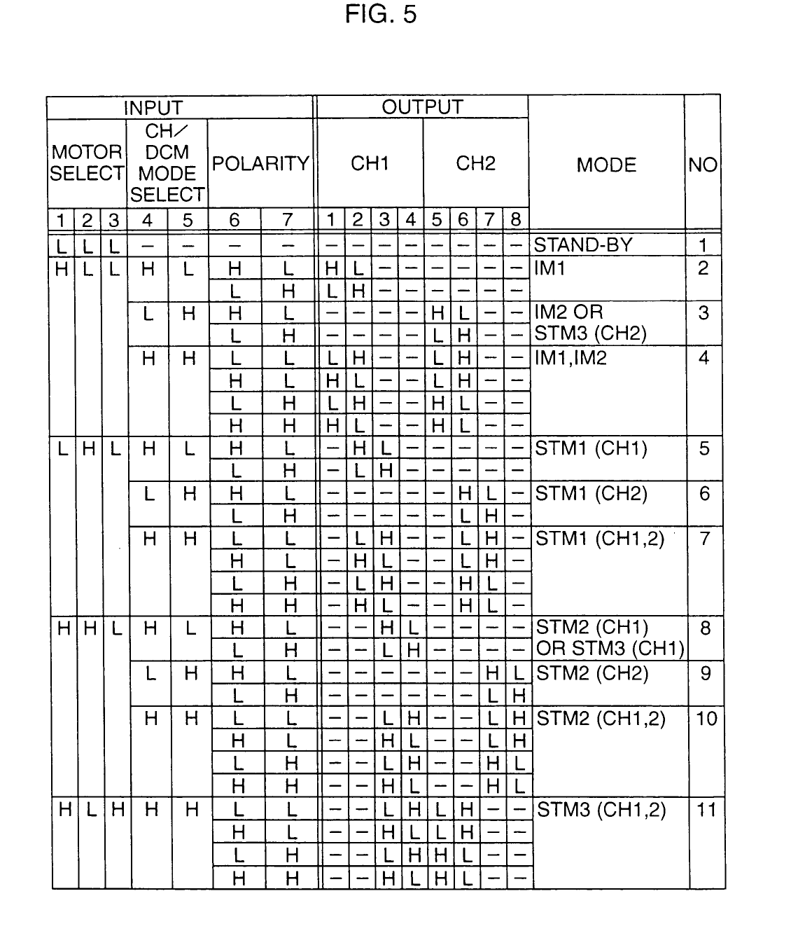

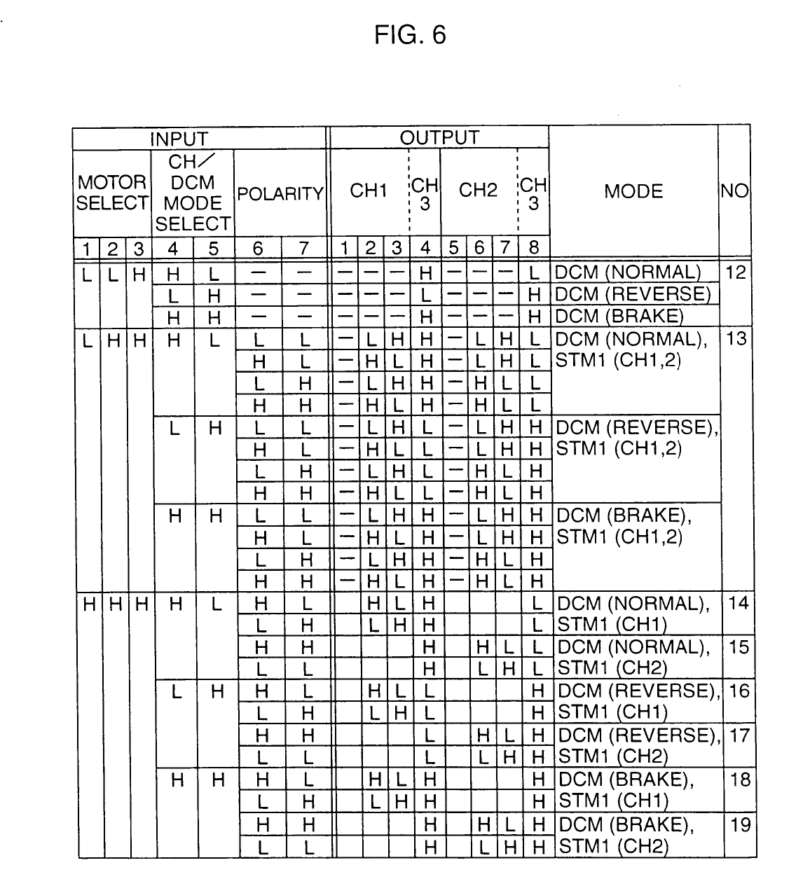

FIGS. 5 and 6 show logic tables of the input/output logic circuit 2 included in the motor driving apparatus shown in FIG. 1. A left column indicates a logic level of the seven input terminals IN1-IN7 and a right column indicates a control output for the channels CH1 and CH2. As shown in them, to select a motor (Motor Select) to be driven, 3-bit data consisting of IN1, IN2, and IN3 is used. Further, to select the channels CH1, CH2 and the DCM motor (CH3), 2-bit data consisting of IN4 and IN5 is used. Further, to specify a motor energizing polarity, 2bit data consisting of IN6 and IN7 is used. It is thus possible to sequentially control the plurality of motors containing a maximum six loads by using a 7-bit input signal.

The logic tables shown in the figures define 19 driving modes by combining the seven data bits. A mode 1 represents a standby state, in which none of the loads is energized and all of them are placed in the standby mode. A mode 2 corresponds to driving of the iris stepping motor IM1 used to drive the shutter. A mode 3 corresponds to driving of the iris motor IM2 for driving the diaphragm. It is to be noted that if the stepping motor STM3 is used in place of the iris motor IM2, the mode 3 corresponds to driving of its coil load on the side of the CH2. A mode 4 corresponds to driving of the iris motors IM1 and IM2. The modes 2, 3, and 4 can be combined to drive the iris motors IM1 and IM2 bi-directionally.

Modes 5, 6, and 7 correspond to 1-2-phase driving of the stepping motor STM1 for AF. That is, two coils of the STM1 are driven in the modes 5 and 6 alternately in 1-phase driving, and are driven simultaneously in the mode 7 in 2-phase driving. The modes 5, 6, and 7 can be combined to enable 1-2-phase driving which is a combination of the 2-phase driving and the 1-phase driving.

Similarly, modes 8, 9, and 10 can be combined to drive the zooming stepping motor STM3 in the 1-2-phase driving mode. Further, the modes 3, 8, and 11 can be combined to drive the zooming stepping motor STM3 in the 1-2-phase driving mode.

Furthermore, in a mode 12, the DC motor DCM for zooming can be driven, that is, rotated in the normal and reverse directions and braked.

Thus, by appropriately combining the modes 1-12, it is possible to accommodate any one of the connections shown in FIGS. 2-4. However, the modes 1-12 correspond to controlling in a case where the zooming DCM is not driven simultaneously with the other motors.

A mode 13 is provided to realize simultaneous driving of the DC motor DCM for zooming and the stepping motor STM1 for AF. However, the stepping motor STM1 is controlled in such a manner that the two coils thereof may always be driven simultaneously and can be operated only in, so-called, the 2-phase driving mode. The 2-phase driving mode is somewhat lacking in rotational smoothness as compared to the above-mentioned 1-2-phase driving mode.

Modes 14-19, if combined with the mode 13 described above, enable 1-2-phase driving of the stepping motor STM1 when driving the DC motor DCM and the stepping motor STM1 simultaneously. Typically, logics to be processed by a logic circuit are increased in circuit scale with an increasing number of bits of an input control signal. In view of a usage frequency, in the invention, preferably the STM is limited to 2-phase excitation when driving the DCM and the STM simultaneously. For this reason, the mode 13 is provided. That is, in the case of independent operation of the STM, the mode 1-11 are employed to enable 1-2-phase excitation of the stepping motor, whereas in the case of simultaneous driving with the DCM, it is limited to 2-phase driving in use. By thus using the modes properly, it is possible to heavily use 1-2-phase excitation while substantially suppressing an increase in number of bits of the control signal. To fully enable 1-2-phase excitation of the stepping motor in all situations, the modes 1-19 are selected. In this case, the logics scale becomes larger than that in a case where the modes 1-13 are selected. It is to be noted that in the modes 12-19, the output terminals 1, 2, and 3 correspond to the CH1, the output terminals 5, 6, and 7 correspond to the CH2, and the output terminals 4 and 8 correspond to the CH3. Here, of course, the logics must be reduced to a minimum against driving specifications.

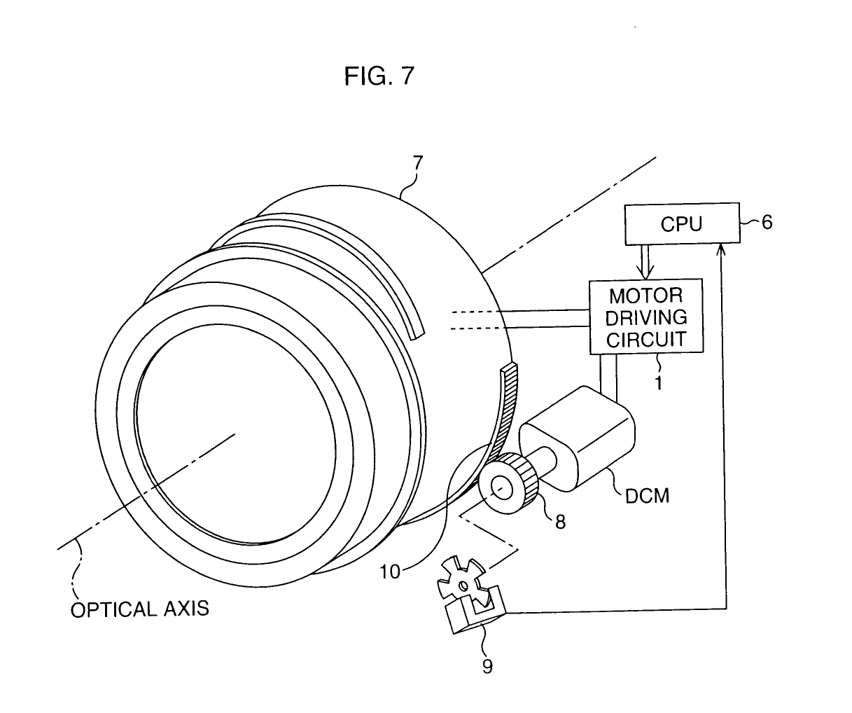

FIG. 7 is a pattern diagram for showing a lens-barrel driving apparatus for camera according to an application of the invention. As shown in it, the lens-barrel driving apparatus for camera basically comprises a lens-barrel 7 and a motor driving circuit 1. The lens-barrel 7 is provided with a plurality of mechanisms used in photographing by camera which are selected from shutter, diaphragm, auto focusing, and zooming mechanisms and also incorporates therein a plurality of motors for driving the plurality of mechanisms. To simplify the illustration, only one of them, that is, the DC motor (DCM) for zooming is shown. The motor driving circuit 1 is a so-called driver IC and integrally comprises a driving circuit for driving a plurality of loads contained in a plurality of motors built in a camera and a control circuit for controlling the driving circuit to thus drive the plurality of motors sequentially.

According to the zooming mechanism shown in the figure, the lens-barrel 7 is incorporated in the camera in such a manner as to advance and retreat along an optical axis. On an outer periphery of the lens-barrel 7 is there formed a rack 10. A pinion 8 is mounted on a shaft of the DCM in such a manner as to mesh with the rack. The motor driving circuit 1 drives the DCM under the control of a camera controlling CPU6, to move the lens-barrel 7 along the optical axis. An encoder 9 detects the number of rotations of the shaft of the DCM and inputs it into the CPU6. The CPU6, based on an output from the encoder 9, controls the motor driving circuit 1, thus performing desired zooming. Although not shown, other motors driving the shutter, diaphragm, auto focusing mechanisms, etc. are similarly driven by the driver IC1 and controlled by the CPU6.

Driving functions utilized by the lens-barrel 7 typically include shutter, diaphragm, auto focusing (AF), and zooming functions. As for a type of an actuator used to drive these, for example, an iris motor (IM) is used to drive the shutter and constituted of one load. The diaphragm is driven by one or two iris motors or by a stepping motor (STM). To drive the AF function, a stepping motor is used often. The zooming function is driven by either a stepping motor or a DC motor (DCM) as shown in the figure. When using a stepping motor for zooming, it is necessary to drive each of two loads (coils) thereof in normal and reverse directions. When using a DC motor for zooming, on the other hand, one load thereof needs to be driven in the normal and reverse directions and braked in driving. Driving braking here means to conduct control so as to short-circuit two ends of the coil. The driver IC (motor driving apparatus 1) is a motor driving apparatus that can commonly drive the above-mentioned combinations of the actuators in a minimum driving circuit configuration and has such a layout as shown in, for example, FIG. 1.

As described above, according to the invention, for example, the shutter can be opened and closed in the constant-current control mode to match with the shutter operation characteristics, although the control accuracy varies with a driving direction. Further, a current value can be set for each of the shutter driving directions. Despite the configuration of placing both the shutter opening and closing operations in the constant-current driving mode, the current detection resistor of the first stage will not become common impedance when the next stage is driven. Such a motor driving apparatus can be constituted of a 24-pin small-sized standard package IC. The open loop-type constant-current control does not require a capacitor to be connected in parallel with the load, which would be required to conduct feedback loop-type constant-current control or constant-voltage control. Furthermore, the feedback loop-type constant electric current control does not require an external resistor because it enables integrating the current setting resistor into the IC chip, thus giving an effect of reducing the number of components.

What is claimed is:

1. A motor driving apparatus comprising:
a driving circuit for driving a plurality of loads contained in a plurality of motors; and
a control circuit for controlling the driving circuit to sequentially drive the plurality of the motors, wherein:
the driving circuit is provided with at least n+1 number of output terminals in order to connect thereto n (n: integer of 2 or larger) number of loads, each of the output terminals being led out from a node of a PNP type transistor and an NPN type transistor connected in series through the node in such a configuration that each pair of the output terminals adjacent to one another constitute a bridge circuit assigned to drive one load;
the control circuit turns on and off the PNP and NPN type transistors of the bridge circuit to thereby energize the load in either of a normal direction and a reverse direction;
a particular one of the output terminals is led from a node of a particular PNP type transistor and a particular NPN transistor, one of which is driven by a constant electric current through a feedback loop and the other of which is driven by a constant electric current through an open loop; and
the particular output terminal and another output terminal adjacent thereto are paired to constitute a particular bridge circuit for driving a particular load by the constant electric current through either of the feedback loop and the open loop properly depending on whether the particular load is energized in the normal direction or the reverse direction.

2. The motor driving apparatus according to claim 1, wherein:
the feedback loop comprises a current detection resistor connected to the one of the particular PNP type transistor and the particular NPN transistor for detecting an electric current flowing therethrough, and an operational amplifier for controlling said one of the particular PNP type transistor and the particular NPN transistor based on an electric current detected by the current detection resistor; and
the open loop comprises a current mirror transistor that is mirror-connected to the other of the particular PNP type transistor and the particular NPN transistor, and a current setting resistor that is connected to the current mirror transistor for setting the constant electric current flowing therethrough.

3. The motor driving apparatus according to claim 2, wherein the driving circuit and the control circuit are integrated into one IC chip, so that the IC chip internally generates a reference voltage inputted to the operational amplifier of the feedback loop for setting the constant electric current, and the current setting resistor of the open loop is connected to the IC chip externally.

4. The motor driving apparatus according to claim 1, wherein the particular bridge circuit constituted of the particular output terminal drives as the particular load a motor contained in a digital camera for opening and closing a shutter in such a manner that the motor is driven by the constant electric current through the open loop when opening the shutter and driven by the constant electric current through the feedback loop when closing the shutter.

5. A lens-barrel driving apparatus for a camera, comprising:
a lens-barrel provided with a plurality of mechanisms for photographing by the camera, which are selected from shutter, diaphragm, auto focusing, and zooming mechanisms;
a plurality of motors that are integrated in order to drive the plurality of the mechanisms;
a driving circuit for driving a plurality of loads contained in the plurality of the motors; and
a control circuit for controlling the driving circuit to sequentially drive the plurality of the motors, wherein:
the driving circuit is provided with at least n+1 number of output terminals in order to connect thereto n (n: integer 2 or larger) number of loads, each of the output terminals being led out from a node of a PNP type transistor and an NPN type transistor connected in series through the node in such a configuration that each pair of the output terminals adjacent to one another constitute a bridge circuit assigned to drive one load;
the control circuit turns on and off the PNP and NPN type transistors of the bridge circuit to thereby energize the load in either of a normal direction and a reverse direction;
a particular one of the output terminals is led from a node of a particular PNP type transistor and a particular NPN transistor, one of which is driven by a constant electric current through a feedback loop and the other of which is driven by a constant electric current through an open loop; and
the particular output terminal and another output terminal adjacent thereto are paired to constitute a particular bridge circuit for driving a particular load by the constant electric current through either of the feedback loop and the open loop properly depending on whether the particular load is energized in the normal direction or the reverse direction.
